(19) United States
(12) Patent Application Publication
(10) Pub. No.: US 2004/0265482 A1
(43) Pub. Date: Dec. 30, 2004

(54) Wiring substrate manufacturing method

(75) Inventors: Yasuyoshi Horikawa, Nagano (JP); Akio Rokugawa, Nagano (JP); Takahiro Iijima, Nagano (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SHINKO ELECTRIC INDUSTRIES CO., LTD., Nagano-shi (JP)

(21) Appl. No.: 10/851,091

(22) Filed: May 24, 2004

(30) Foreign Application Priority Data
Jun. 30, 2003 (JP) 2003-187669

(51) Int. Cl. B05D 5/12

(52) U.S. Cl. 427/96.1

(57) ABSTRACT

The present invention includes the steps of preparing a core substrate having a through hole therein, arranging the conductive parts in the through hole in a state that a top end side of the conductive parts forms a projected portion projected from the core substrate, by inserting a conductive parts having a length, which is longer than a thickness of the core substrate, into the through hole of the core substrate, forming an insulating film on the core substrate to coat the projected portion of the conductive parts, and planarizing the insulating film by grinding the insulating film.

### BACKGROUND OF THE INVENTION

1. Field of the Invention

The present invention relates to a wiring substrate manufacturing method and, more particularly, a method of manufacturing a wiring substrate having a structure capable of getting conductivity between both surface sides of a core substrate via through holes provided in the core substrate.

2. Description of the Related Art

Conventionally there is the wiring substrate having the structure in which wiring patterns formed on both surface sides of the core substrate are connected mutually via through holes in the core substrate. In such wiring substrate, a copper plating layer, a conductive paste, a metal pillar (a metal pin or a metal wire), or the like is filled in the through holes in the core substrate. In order to fill the conductive material in the through holes with a high aspect ratio at a low cost and with good reliability, sometimes a method of inserting the metal pillar into the through holes is more favorable than a method of filling the through holes with the copper plating layer or the conductive paste.

The wiring substrate having the structure in which the metal pillar is inserted into the through holes provided in the core substrate is set forth in Patent Literature 1 (Patent Application Publication (KOKAI) Sho 62-98694) and Patent Literature 2 (Patent Application Publication (KOKAI) 2002-289999), for example.

In the method of inserting the metal pillar into the through holes, in order to assure the conduction between both surface sides of the core substrate, normally the metal pillar whose length is set longer than a thickness of the core substrate (a depth of the through hole) is inserted into the through holes. Hence, the metal pillar is arranged in the through holes in a state that such metal pillar has its projected portions projected from both surfaces of the core substrate.

Also, in case the core substrate having the wiring patterns thereon is employed, in order to assure reliability of electrical connections between the metal pillars and the wiring patterns, sometimes the projected portions of the metal pillars are crashed by the caulking process and then the plating is applied to these connection portions after the metal pillar is inserted into the through holes.

In this manner, when the metal pillar is inserted into the through holes of the core substrate, level differences are generated by the projected portions of the metal pillars on both surfaces of the core substrate. Therefore, such a problem exists that, upon laminating the interlayer insulating films and the wiring patterns on the core substrate, it becomes difficult to form fine multi-layered wirings at a high density because of the influence of the level differences.

In order to avoid such problem, in Patent Literature 3 (Patent Application Publication (KOKAI) 2001-352166), it is set forth that the through-hole parts in which outer peripheral portions of core wires (metal pillars) are covered with the resin is inserted into the through holes of the core substrate, and then top end surfaces of the through-hole parts and surfaces of the core substrate are planarized by polishing the core wires of the through-hole parts (metal pillars) and the resin at the same time so as to get a coplanar surface.

However, according to the method in Patent Literature 3, such an effect can be achieved that the level differences caused by the through-hole parts can be dissolved, nevertheless it is possible to deform the metal pillars or extend the polished metal piece onto the polished surface since the resin of the through-hole parts and the metal pillars are polished simultaneously to planarize. As a result, it is supposed that the metal pillars cannot be polished with good reliability.

### SUMMARY OF THE INVENTION

It is an object of the present invention to provide a wiring substrate manufacturing method capable of planarizing level differences caused by projections of metal pillars without any trouble in a wiring substrate having a structure in which conductive parts having projected portions projected from a core substrate are inserted into through holes of the core substrate.

The present invention is related to a wiring substrate manufacturing method which comprises the steps of preparing a core substrate having a through hole therein; arranging the conductive parts in the through hole in a state that a top end side of the conductive parts forms a projected portion projected from the core substrate, by inserting a conductive parts having a length, which is longer than a thickness of the core substrate, into the through hole of the core substrate; forming an insulating film on the core substrate to coat the projected portion of the conductive parts; and planarizing the insulating film by plating the insulating film.

In the present invention, the conductive parts (metal pillar, or the like) whose length is longer than a thickness of the insulating substrate is inserted into the through holes of the insulating substrate, and then the conductive parts is arranged in the through holes of the insulating substrate in a state that such conductive parts has its projected portions projected from the insulating substrate. Then, the insulating layer for coating the projected portions of the conductive parts is formed on the insulating substrate, and then the insulating layer is planarized by the polishing or the grinding.

In the present invention, the level differences due to the projected portions of the conductive parts are eliminated not by polishing the projected portions themselves of the conductive parts to planarize but by polishing merely the insulating layers in the condition that the projected portions of the conductive parts are covered/held with the insulating layers. Therefore, it is not possible to generate disadvantages such as deformation of the conductive parts in the polishing step, and thus the level differences due to the projected portions of the conductive parts can be eliminated by planarizing the insulating layers with good reliability.

As a result, since the level differences due to the projected portions of the conductive parts are eliminated when the wiring patterns connected to the conductive parts are formed over the conductive parts, a precision in the photolithography can be improved. Therefore, the fine multi-layered wiring patterns can be formed with good precision and also the high-density wiring substrate can be manufactured easily.

In one preferred mode of the present invention, in the step of planarizing the insulating film, the insulating film may be left on the conductive parts, or the insulating film may be polished until a top end surface of the conductive parts is exposed. Alternately, an upper insulating film for coat the conductive parts may be formed further after the insulating film is polished until a top end surface of the conductive parts is exposed.

Also, the insulating substrate, the metal plate, or the metal base substrate having the laminated structure of a metal plate and an insulating layer is used as the core substrate. When the metal plate or the metal base substrate is used, the generation of the electric short-circuit between the conductive parts can be prevented by using the conductive parts having the coaxial structure, which is formed by coating the insulating member on the outer peripheral portion of the metal pillar, as the conductive parts.

### BRIEF DESCRIPTION OF THE DRAWINGS

FIGS. 1A to 1I are sectional views showing a wiring substrate manufacturing method according to a first embodiment of the present invention;

FIGS. 2A to 2D are sectional views showing a variation of the wiring substrate manufacturing method according to the first embodiment;

FIGS. 3A to 3D are sectional views showing a wiring substrate manufacturing method according to a second embodiment of the present invention;

FIGS. 4A to 4D are sectional views showing a wiring substrate manufacturing method according to a third embodiment of the present invention;

FIGS. 5A to 5F are sectional views showing a wiring substrate manufacturing method according to a fourth embodiment of the present invention; and

FIGS. 6A to 6F are sectional views showing a wiring substrate manufacturing method according to a fifth embodiment of the present invention.

### DETAILED DESCRIPTION OF THE PREFERRED EMBODIMENTS

Embodiments of the present invention will be explained with reference to the drawings hereinafter.

### First Embodiment

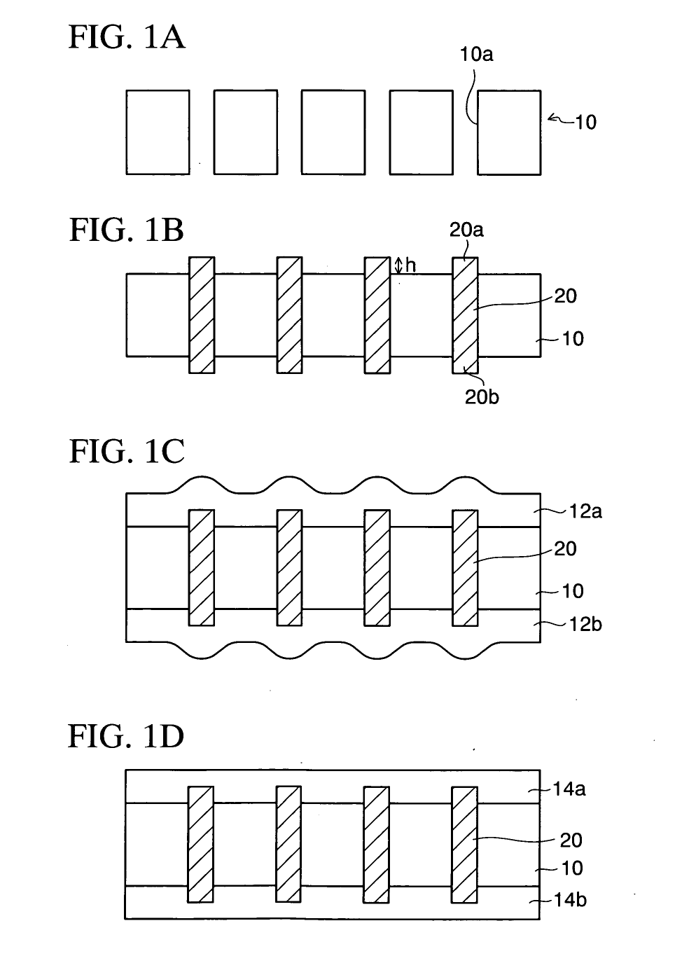

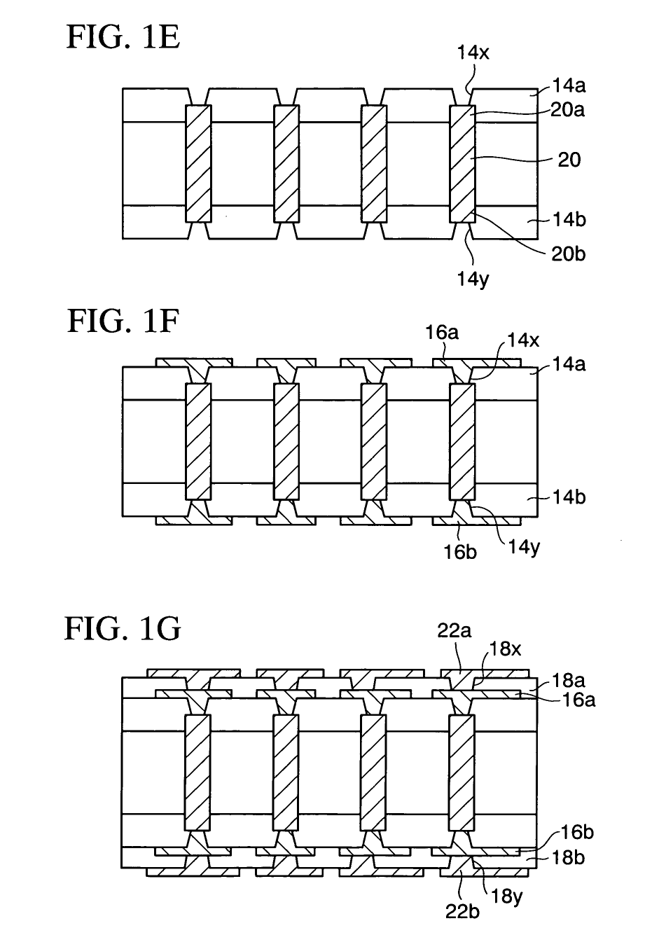

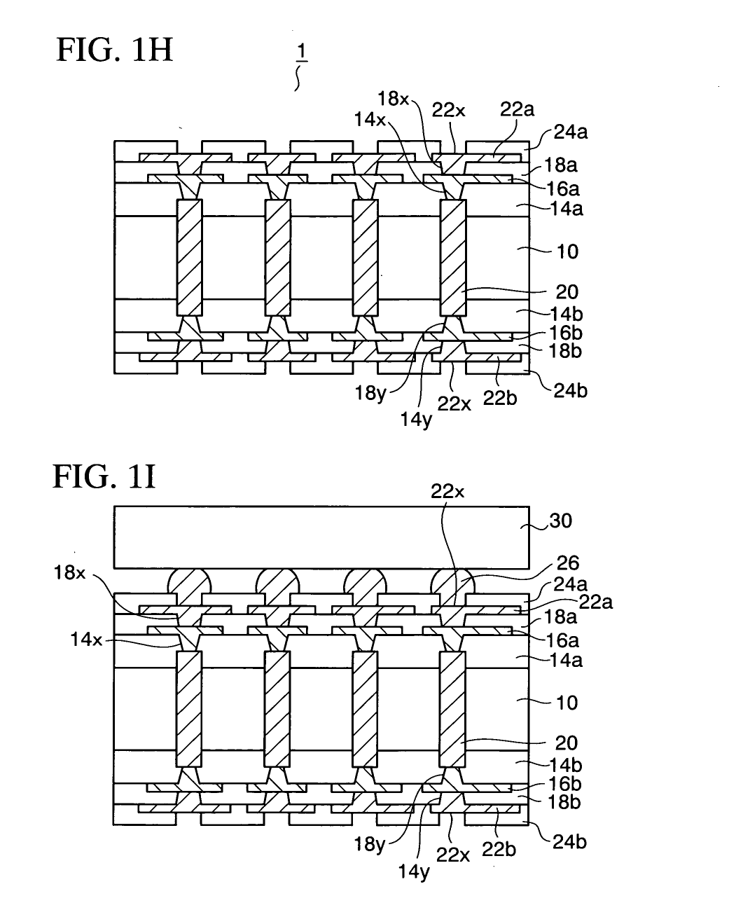

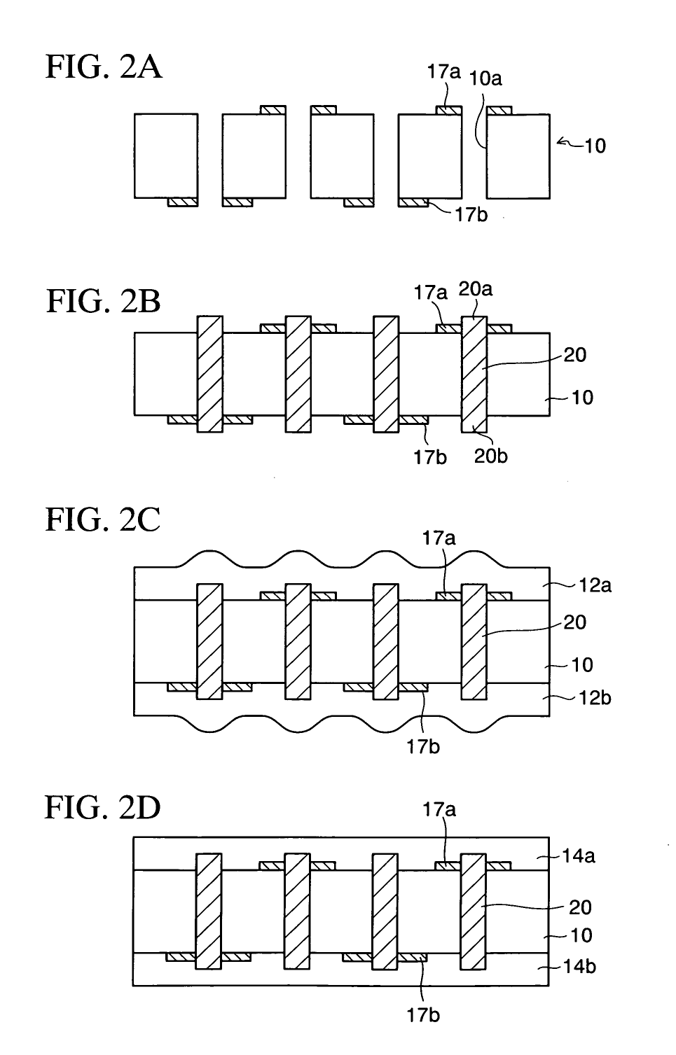

FIGS. 1A to 1I are sectional views showing a wiring substrate manufacturing method according to a first embodiment of the present invention, and FIGS. 2A to 2D are sectional views showing a variation of the wiring substrate manufacturing method according to the first embodiment.

In the wiring substrate manufacturing method according to the present embodiment, as shown in FIG. 1A, first an insulating substrate 10 is prepared as a core substrate, and then through holes 10a are formed in the insulating substrate 10 by drilling, punching, or the like. For example, a thickness of the insulating substrate is 300 to 500 μm, and a diameter of the through hole 10a is set to 100 to 300 μm. As the insulating substrate 10, either a rigid substrate such as a glass epoxy substrate, or the like or a flexible substrate is employed.

Then, as shown in FIG. 1B, conductive parts 20 that are inserted into the through holes 10a of the insulating substrate 10 are prepared. In this conductive parts 20, its diameter corresponds to the diameter of the through hole 10a of the insulating substrate 10, and its length is set longer than a thickness of the insulating substrate 10. Then, the conductive parts 20 are inserted into the through holes 10a of the insulating substrate 10 and then fixed. As the conductive parts 20, a metal pillar prepared by cutting a metal wire made of copper (Cu), Cu alloy, solder, or the like to a predetermined length is employed.

At this time, the conductive parts 20 are fitted into the through holes 10a in a state that their projected portions 20a, 20b are projected from both surfaces of the insulating substrate 10 respectively. For example, a height h of the projected portions 20a, 20b from the insulating substrate 10 is set to 20 to 60 μm.

Then, as shown in FIG. 1C, the projected portions 20a, 20b of the conductive parts 20 are coated by forming insulating layers 12a, 12b on both surfaces of the insulating substrate 10 respectively. Preferably a thickness of the insulating layer 12a should be set thicker than a height h of the projected portions 20a, 20b of the conductive parts 20. As an example of the insulating layers 12a, 12b, a resin film made of epoxy resin, polyphenylene ether resin, phenol resin, fluororesin, or the like is employed. The resin film is laminated or pressed on both surfaces of the insulating substrate 10 respectively, and then cured by the heating process. Alternately, a resin coating liquid may be coated on both surfaces of the insulating substrate 10 by screen printing, roller coating, or the like, and then cured by the heating process. At this time, the insulating layers 12a, 12b are formed to have the unevenness due to the influence of level differences of the projected portions 20a, 20b of the conductive parts 20.

Then, as shown in FIG. 1D, the insulating layers 12a, 12b on both surface sides of the insulating substrate 10 are ground by a predetermined film thickness respectively. Thus, the level differences due to the projected portions 20a, 20b of the conductive parts 20 are eliminated, and exposed surfaces of the insulating layers 12a, 12b are made flat. Then, remaining insulating layers 12a, 12b constitute first interlayer insulating films 14a, 14b that are flattened respectively. This step is carried out by buff polishing, belt polishing, or tape polishing, for example. The insulating layers 12a, 12b on both surface sides of the insulating substrate 10 are polished simultaneously by this step. Alternately, the insulating layers 12a, 12b may be ground by a grinder.

At this time, in the first embodiment, the insulating layers 12a, 12b are polished to planarize such that the insulating layers 12a, 12b still remain on the conductive parts 20 not to expose top end surfaces of the conductive parts 20.

In the present embodiment, the conductive parts 20 itself is not polished, but merely the insulating layers 12a, 12b are polished to execute the planarization in a state that the projected portions 20a, 20b of the conductive parts 20 are covered/held with the insulating layers 12a, 12b. Therefore, unlike the prior art, there is no possibility to deform the conductive parts (metal pillars) 20 or to extend the polished metal piece onto the polished surface.

In case the rigid substrate such as the glass epoxy substrate, or the like is employed as the insulating substrate 10, it is extremely difficult to planarize the insulating substrate 10 by the polishing since glass cloths are present in the substrate. However, in the present embodiment, as described above, it is not required to polish the insulating substrate 10. Therefore, even though the glass epoxy substrate, or the like is employed, the flat surface can be obtained not to generate any trouble.

As a variation of the first embodiment, as shown in FIG. 2A, a substrate having wiring layers 17a, 17b formed of a copper foil on both surfaces (or a single surface) may be employed as the insulating substrate 10. Then, the through holes 10a are formed in the insulating substrate 10.

Then, as shown in FIG. 2B, in compliance with the same method as the foregoing method, the conductive parts 20 are inserted into the through holes 10a of the insulating substrate 10 and then fixed. At this time, the conductive parts 20 are connected electrically to the wiring layers 17a, 17b of the insulating substrate 10. In the event that reliability of the jointing between the conductive parts 20 and the wiring layers 17a, 17b should be improved, contact areas between the conductive parts 20 and the wiring layers 17a, 17b may be increased by crashing the conductive parts 20 by means of the caulking process.

Then, as shown in FIGS. 2C and 2D, the flat interlayer insulating films 14a, 14b are obtained by forming the insulating layers 12a, 12b on both surfaces of the insulating substrate 10 respectively and then polishing such insulating layers 12a, 12b.

In case the insulating substrate 10 having the wiring layers 17a, 17b thereon as described above is employed, the wiring layers 17a, 17b are protected by the insulating layers 12a, 12b. Therefore, the wiring layers 17a, 17b are in no way damaged when such insulating layers 12a, 12b are polished to get the flat surface.

After the flat first interlayer insulating films 14a, 14b are obtained as described above, as shown in FIG. 1E, portions of the first interlayer insulating films 14a, 14b on the conductive parts 20 on both surface sides of the insulating substrate 10 are worked by a laser, a plasma etching, or the like. Thus, first via holes 14x, 14y having a depth that reaches the top end surface of the conductive parts 20 are formed respectively.

Then, as shown in FIG. 1F, first wiring patterns 16a, 16b connected to the conductive parts 20 respectively are formed on the first interlayer insulating films 14a, 14b on both surface sides of the insulating substrate 10 via the first via holes 14x, 14y respectively. The first wiring patterns 16a, 16b are formed by the semi-additive process, for example. In more detail, a seed Cu layer is formed on inner surfaces of the first via holes 14x, 14y on both surface sides of the insulating substrate 10 and on the first interlayer insulating films 14a, 14b by the electroless plating or the sputter respectively. Then, a resist film (not shown) having predetermined opening portions corresponding to the first wiring patterns 16a, 16b is formed by the photolithography.

Then, Cu film patterns are formed in the opening portions of the resist film by the electroless plating using the seed Cu film as a plating power-supplying layer. Then, the resist film is removed, and then the seed Cu film is etched while using the Cu film patterns as a mask. Thus, the first wiring patterns 16a, 16b connected to the conductive parts 20 via the first via holes 14x, 14y are formed on the first interlayer insulating films 14a, 14b on both surface sides of the insulating substrate 10 respectively.

In this case, the first wiring patterns 16a, 16b may be formed by the subtractive process, the full additive process, or the like in place of the semi-additive process.

In the present embodiment, since the first interlayer insulating films 14a, 14b are made flat in the step of forming the first wiring patterns 16a, 16b, a focal depth in the photolithography can be set small. Therefore, since there is no possibility to generate the defocus in the photolithography step, the first wiring patterns 16a, 16b can be formed stably with good precision.

Then, as shown in FIG. 1G, second interlayer insulating films 18a, 18b are formed on both surface sides of the insulating substrate 10 respectively. Then, second via holes 18x, 18y are formed in portions of the second interlayer insulating films 18a, 18b on the first wiring patterns 16a, 16b respectively.

Then, second wiring patterns 22a, 22b connected to the first wiring patterns 16a, 16b via the second via holes 18x, 18y are formed on the second interlayer insulating films 18a, 18b respectively. The second wiring patterns 22a, 22b are formed by the same method as the foregoing method used to form first wiring patterns 16a, 16b.

Then, as shown in FIG. 1H, solder resist films 24a, 24b in which opening portions are provided on connection portions 22x of the second wiring patterns 22a, 22b are formed on both surface sides of the insulating substrate 10 respectively. Then, the Ni/Au plating is applied to the connection portions 22x of the second wiring patterns 22a, 22b. Then, when a large-size insulating substrate 10 is employed to get a plurality of wiring substrates, individual wiring substrates 1 are obtained by cutting this insulating substrate 10.

With the above, the wiring substrate 1 manufactured by the wiring substrate manufacturing method according to the first embodiment is obtained.

In this case, in the present embodiment, a mode where double-layered wiring patterns are laminated on both surface sides of the insulating substrate 10 respectively is exemplified. It is of course that the present invention can be applied to various modes where n-layered (n is an integer of 1 or more) wiring patterns are laminated. In such case, since each interlayer insulating film is formed to planarize respectively, laminated wiring patterns can be formed without any trouble. Also, the wiring patterns may be laminated on one surface of the insulating substrate 10.

In the wiring substrate 1 of the present embodiment, as shown in FIG. 1I, for example, bumps 26 of a semiconductor chip 30 having the bumps 26 thereon are bonded to the connection portions 22x of the upper second wiring patterns 22a. Then, the connection portions 22x of the lower second wiring patterns 22b are connected to connection terminals of a mounting substrate (mother board) via the bumps.

As described above, in the wiring substrate manufacturing method according to the present embodiment, first the conductive parts 20 is inserted into the through holes 10a of the insulating substrate 10 in a state that such conductive parts 20 has the projected portions 20a, 20b projected from both surfaces of the insulating substrate 10. Then, the insulating layers 12a, 12b for covering the projected portions 20a, 20b of the conductive parts 20 are formed on both surfaces of the insulating substrate 10, and then such insulating layers 12a, 12b are polished. Thus, the first interlayer insulating films 14a, 14b whose surfaces are made flat are obtained.

In the present embodiment, the projected portions 20a, 20b themselves of the conductive parts 20 are not ground to planarize, but merely the insulating layers 12a, 12b are polished in the condition that the projected portions 20a, 20b of the conductive parts 20 are covered/held with the insulating layers 12a, 12b. As a result, in the step of polishing the insulating layers 12a, 12b, disadvantages such as the deformation of the conductive parts (metal pillar) 20, etc. are by no means generated, and thus the level differences due to the projected portions 20a, 20b of the conductive parts 20 can be eliminated to get the planarization.

Accordingly, a precision in the photolithography can be improved when the first wiring patterns 16a, 16b connected to the conductive parts 20 are formed over the conductive parts 20. Therefore, the fine wiring patterns can be formed with good precision and also the high-density wiring substrate can be manufactured easily.

Also, since the conductive parts (metal pillar) is inserted into the through holes of the core substrate respectively, even the through holes with a high aspect ratio, that the plating or the conductive paste are difficult to fill, can make conductive both surfaces of the substrate to have a low resistance. In addition to this, since the multi-layered wiring having a stacked via structure can be formed easily by arranging via holes on the conductive parts, not only the higher density of the wirings can be easily attained but also reduction in the wiring inductance can be attained because of shorter wiring routes.

### Second Embodiment

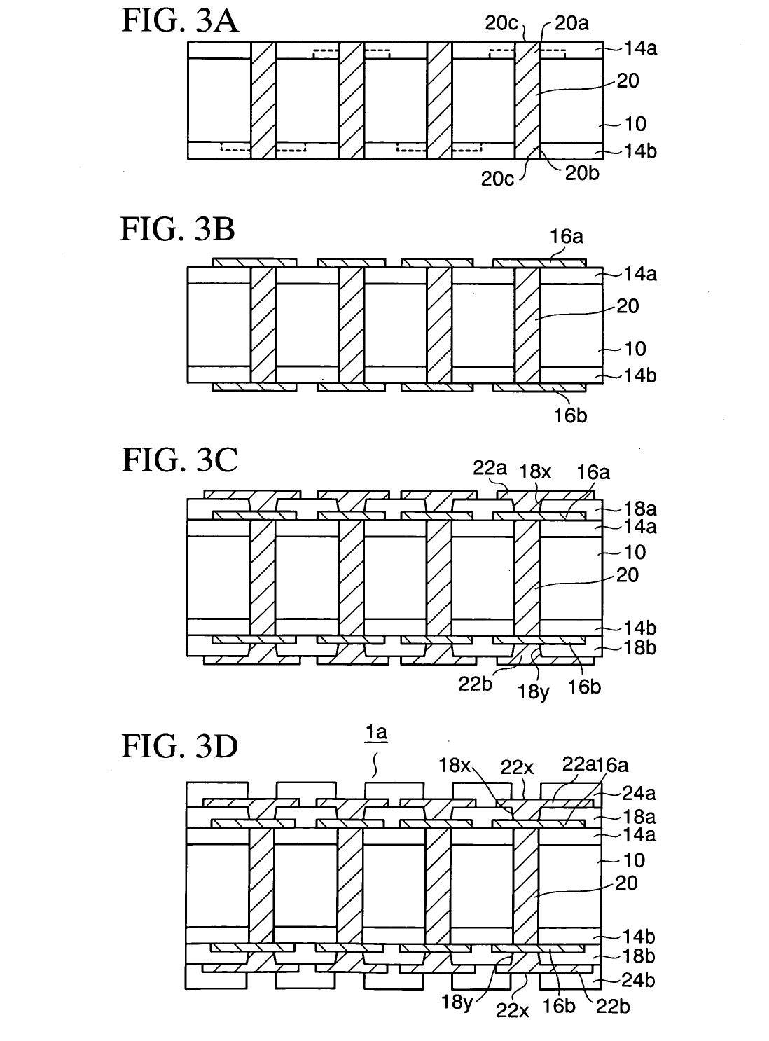

FIGS. 3A to 3D are sectional views showing a wiring substrate manufacturing method according to a second embodiment of the present invention. A difference of the second embodiment from the first embodiment resides in that, in the step of polishing the insulating layer, the insulating layer is polished until the top end surfaces of the conductive parts are exposed. In the second embodiment, detailed explanation of the same steps as those in the first embodiment will be omitted hereunder.

In the second embodiment, first the same structure as that shown in FIG. 1C in the first embodiment is formed. In the second embodiment, in addition to the metal pillar, a conductive parts having a coaxial structure in which an insulating member is coated on an outer peripheral portion of the metal pillar, as described later in a fourth embodiment, may be employed as the conductive parts 20. Then, the insulating layers 12a, 12b on both surface sides of the insulating substrate 10 are polished by the similar method to the first embodiment. At this time, in the second embodiment, as shown in FIG. 3A, the insulating layers 12a, 12b are polished until top end surfaces 20c of the conductive parts 20 are exposed. In the second embodiment, the insulating layers 12a, 12b remaining in the lateral direction of the projected portions 20a, 20b of the conductive parts 20 serve as the first interlayer insulating films 14a, 14b respectively. At this time, when metal powders are left on the first interlayer insulating films 14a, 14b by the polishing, such metal powders are removed by an etchant. Also, like the variation of the first embodiment, when the insulating substrate 10 having wiring layers (portions indicated with a broken line in FIG. 3A) is employed, there is no possibility that the wiring layers are damaged upon the polishing.

Then, as shown in FIG. 3B, according to the same method as that in the first embodiment, the first wiring patterns 16a, 16b connected to the conductive parts 20 on both surface sides of the insulating substrate 10 are formed on the first interlayer insulating films 14a, 14b respectively.

Then, as shown in FIG. 3C, according to the same method as that in the first embodiment, a structure in which the second wiring patterns 22a, 22b are connected to the first wiring patterns 16a, 16b via the second via holes 18x, 18y provided in the second interlayer insulating films 18a, 18b is formed.

Then, as shown in FIG. 3D, the solder resist films 24a, 24b in which the opening portions are provided on the connection portions 22x of the second wiring patterns 22a, 22b are formed respectively. Then, the Ni/Au plating is applied to the connection portions 22x of the second wiring patterns 22a, 22b.

With the above, a wiring substrate 1a according to the second embodiment is obtained. The second embodiment can achieve the same advantage as the first embodiment, and can simplify manufacturing steps rather than the first embodiment and reduce a production cost because the step of forming the first via holes 14x, 14y in the first embodiment is unnecessary.

### Third Embodiment

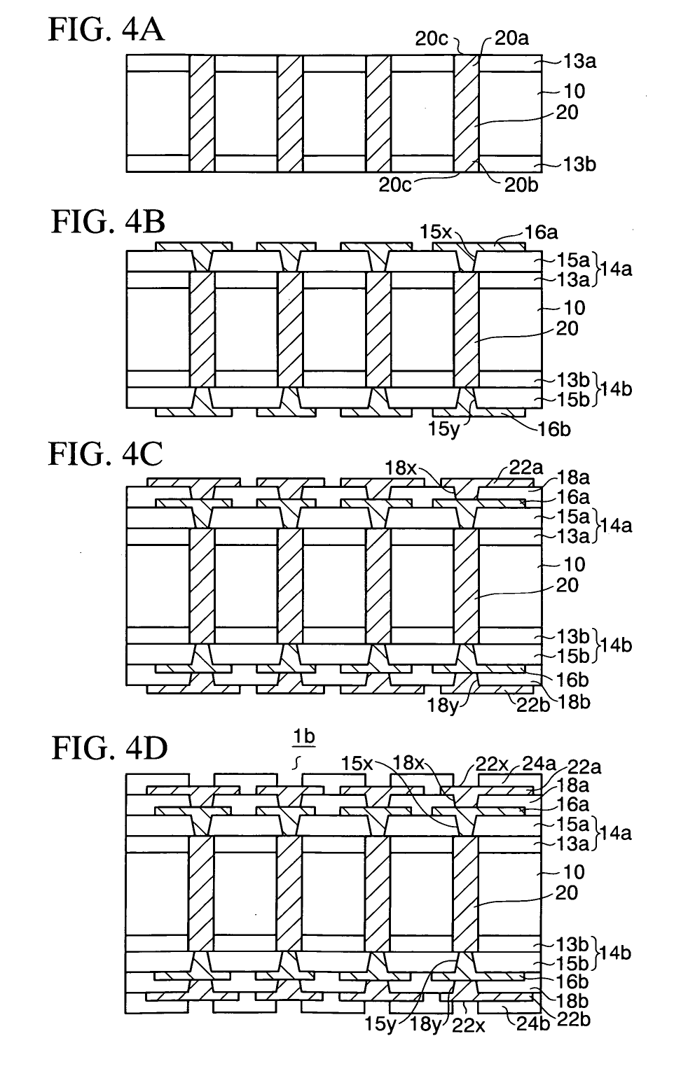

FIGS. 4A to 4D are sectional views showing a wiring substrate manufacturing method according to a third embodiment of the present invention. A difference of the third embodiment from the second embodiment resides in that the conductive parts are covered further with the insulating layer after the top end surfaces of the conductive parts are exposed by polishing the insulating layer. In the third embodiment, detailed explanation of the same steps as those in the first embodiment will be omitted hereunder.

First, as shown in FIG. 4A, like the second embodiment, the insulating layers 12a, 12b of the structure shown in FIG. 1C are polished to expose the top end surfaces 20c of the conductive parts 20 in such a manner that first insulating layer 13a, 13b are left in the lateral direction of the projected portions 20a, 20b of the conductive parts 20 on both surface sides of the insulating substrate 10 respectively. In the third embodiment, in addition to the metal pillar, the conductive parts having the coaxial structure in which the insulating member is coated on the outer peripheral portion of the metal pillar may also be employed as the conductive parts 20.

Then, in the third embodiment, as shown in FIG. 4B, second insulating layers 15a, 15b (upper insulating layers) for coating the top end surfaces 20c of the conductive parts 20 on both surface sides of the insulating substrate 10 are formed respectively. Thus, the first interlayer insulating films 14a, 14b composed of the first insulating layers 13a, 13b and the second insulating layers 15a, 15b respectively are formed on both surface sides of the insulating substrate 10 respectively.

Then, first via holes 15x, 15y are formed in portions of the second insulating layers 15a, 15b on the conductive parts 20 on both surface sides of the insulating substrate 10 respectively. Then, the first wiring patterns 16a, 16b connected to the conductive parts 20 via the first via holes 15x, 15y respectively are formed on the first interlayer insulating films 14a, 14b respectively.

Then, as shown in FIG. 4C, according to the same method in the first embodiment, the structure in which the second wiring patterns 22a, 22b are connected to the first wiring patterns 16a, 16b via the second via holes 18x, 18y provided in the second interlayer insulating films 18a, 18b is formed.

Then, as shown in FIG. 4D, like the first embodiment, the solder resist films 24a, 24b in which the opening portions are provided on the connection portions 22x of the second wiring patterns 22a, 22b are formed respectively. Then, the Ni/Au plating is applied to the connection portions 22x of the second wiring patterns 22a, 22b.

With the above, a wiring substrate 1b according to the third embodiment is obtained. The third embodiment can attain the similar advantages to those in the first embodiment.

### Fourth Embodiment

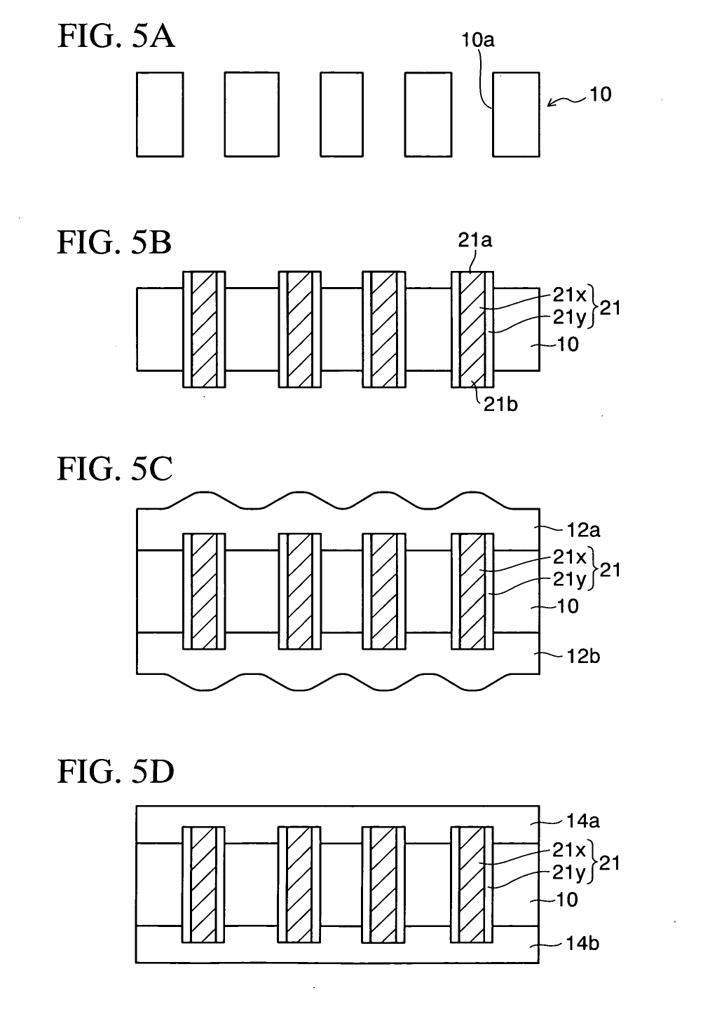

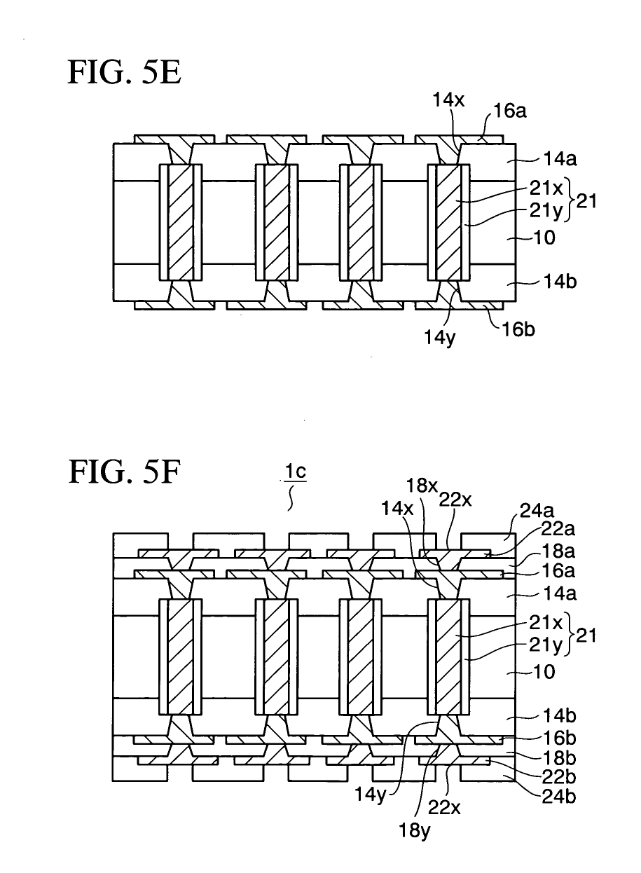

FIGS. 5A to 5F are sectional views showing a wiring substrate manufacturing method according to a fourth embodiment of the present invention. A difference of the fourth embodiment from the first embodiment resides in that the conductive parts having the coaxial structure in which the insulating member is coated on the outer peripheral portion of the metal pillar may also be employed as the conductive parts.

First, as shown in FIG. 5A, like the first embodiment, the insulating substrate 10 is prepared as a core substrate, and then the through holes 10a are formed in the insulating substrate 10. Then, as shown in FIG. 5B, coaxial conductive parts 21 composed of a metal pillar 21x and an insulating member 21y that coats an outer peripheral portion of the metal pillar 21x are prepared.

A length of the coaxial conductive parts 21 is set longer than a thickness of the insulating substrate 10, like the first embodiment. Also, a diameter of the coaxial conductive parts 21 is set to respond to the through hole 10a in the insulating substrate 10, a diameter of the metal pillar 21x is 100 to 150 μm, for example, and a thickness of the insulating member 21y is 40 to 60 μm, for example. The insulating member 21y of the coaxial conductive parts 21 is made of epoxy resin, polyimide resin, polyamide/imide resin, fluororesin, polyethylene resin, or the like. Either a single-layer insulating layer or an insulating layer formed by laminating two different insulating layers or more may be employed.

Then, the coaxial conductive parts 21 is inserted into the through holes 10a of the insulating substrate 10 and then fixed. At this time, like the first embodiment, the coaxial conductive parts 21 is fitted into the through holes 10a in a state that projected portions 21a, 21b are projected to both surface sides of the insulating substrate 10. Since the insulating member 21y is coated on the outer peripheral portion, the electric short-circuit can be prevented in the coaxial conductive parts 21 even though the coaxial conductive parts 21 are arranged mutually closely. Therefore, a pitch between the through holes 10a of the insulating substrate 10 can be set narrower than the case the conductive parts 20 made of a single body of the metal pillar are employed in the first embodiment. In this manner, the present embodiment can deal easily with the higher density of the wiring substrate by employing the coaxial conductive parts 21.

Then, as shown in FIGS. 5C and 5D, the insulating layers 12a, 12b that are formed to coat the projected portions. 21a, 21b of the coaxial conductive parts 21 on both surface sides of the insulating substrate 10 are polished by the same method as the first embodiment. Thus, the planarized first interlayer insulating films 14a, 14b are obtained.

Then, as shown in FIG. 5E, the structure in which the first wiring patterns 16a, 16b are connected to the coaxial conductive parts 21 via the first via holes 14x, 14y provided in the first interlayer insulating films 14a, 14b is formed by the same method as the first embodiment.

Then, as shown in FIG. 5F, the structure in which the second wiring patterns 22a, 22b are connected to the first wiring patterns 16a, 16b via the second via holes 18x, 18y provided in the second interlayer insulating films 18a, 18b is formed by the same method as the first embodiment.

Then, like the first embodiment, the solder resist films 24a, 24b in which the opening portions are provided on the connection portions 22x of the second wiring patterns 22a, 22b are formed respectively. Then, the Ni/Au plating is applied to the connection portions 22x of the second wiring patterns 22a, 22b.

With the above, a wiring substrate 1c according to the fourth embodiment is obtained. The fourth embodiment can attain the same advantages as the first embodiment and also can deal easily with the higher density of the wiring substrate since the coaxial conductive parts 21 is employed as above.

### Fifth Embodiment

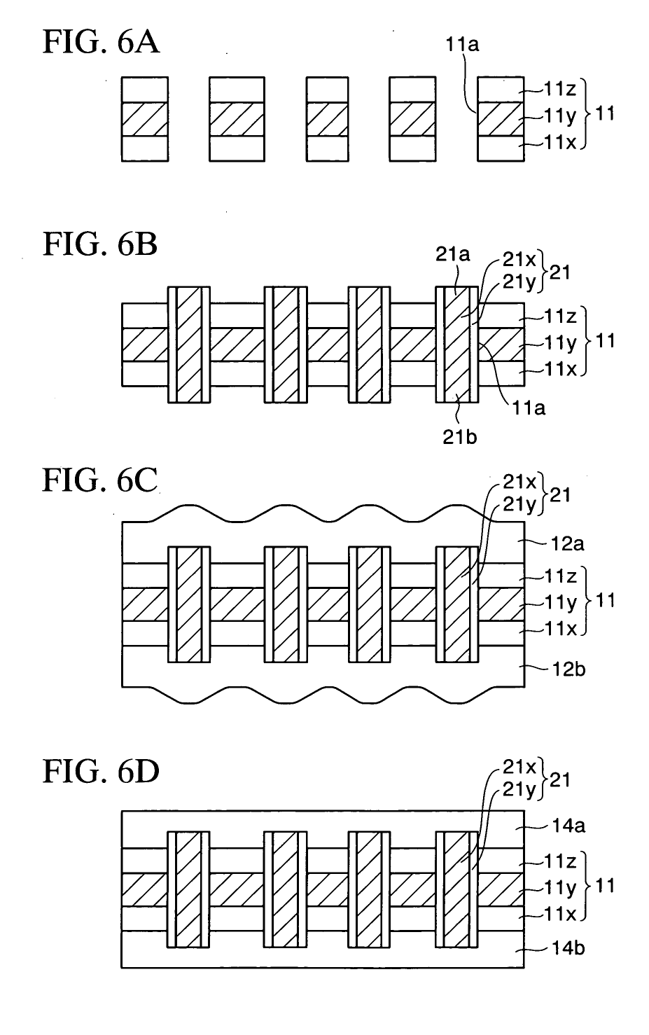

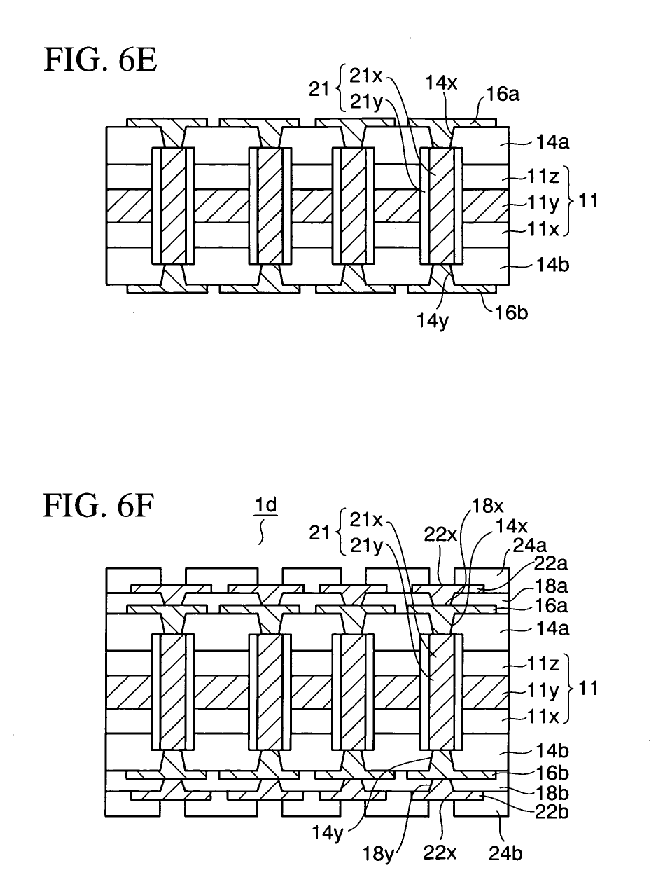

FIGS. 6A to 6F are sectional views showing a wiring substrate manufacturing method according to a fifth embodiment of the present invention. A difference of the fifth embodiment from the first embodiment resides in that the same coaxial conductive parts as that in the fourth embodiment is employed and a substrate using a metal plate as a base is employed as the core substrate.

First, as shown in FIG. 6A, a metal base substrate 11 consisting of a lower insulating layer 11x, a metal plate 11y, and an upper insulating layer 11z is prepared, and then through holes 11a are formed in the metal base substrate 11. For example, thicknesses of the lower insulating layer 11x and the upper insulating layer 11z are set to about 100 μm respectively, and a thickness of the metal plate 11y is set to about 200 μm. A resin film, or the like is employed as the lower insulating layer 11x and the upper insulating layer 11z, and a copper plate, an alloy plate consisting of iron (Fe)-nickel (Ni), or the like is employed as the metal plate 11y. In this case, a single body of the metal plate onto which the insulating layer is not pasted may be employed instead of the metal base substrate 11.

Then, as shown in FIG. 6B, like the fourth embodiment, the coaxial conductive parts 21 composed of the metal pillar 21x and the insulating member 21y that coats the outer peripheral portion of the metal pillar 21x are prepared. A length of the coaxial conductive parts 21 is set longer than a thickness of the metal base substrate 11.

Then, the coaxial conductive parts 21 is inserted into the through holes 11a of metal base substrate 11 and then fixed. At this time, the coaxial conductive parts 21 is fitted into the through holes 11a in a state that the projected portions 21a, 21b are protruded from both surface sides of the metal base substrate 11. Also at this time, since the coaxial conductive parts 21 has the insulating member 21y on the outer peripheral portion, a plurality of coaxial conductive parts 21 are never short-circuited electrically mutually via the metal plate 11y of the metal base substrate 11, and plural coaxial conductive parts 21 are isolated mutually.

Then, as shown in FIGS. 6C and 6D, the insulating layers 12a, 12b formed to coat the projected portions 21a, 21b of the coaxial conductive parts 21 on both surface sides of the metal base substrate 11 are polished by the same method as the first embodiment. Thus, the first interlayer insulating films 14a, 14b whose surfaces are planarized are obtained.

Then, as shown in FIG. 6E, the structure in which the first wiring patterns 16a, 16b are connected to the coaxial conductive parts 21 via the first via holes 14x, 14y provided in the first interlayer insulating films 14a, 14b is formed by the same method as the first embodiment.

Then, as shown in FIG. 6F, the structure in which the second wiring patterns 22a, 22b are connected to the first wiring patterns 16a, 16b via the second via holes 18x, 18y provided in the second interlayer insulating films 18a, 18b is formed by the same method as the first embodiment.

Then, like the first embodiment, the solder resist films 24a, 24b in which the opening portions are provided on the connection portions 22x of the second wiring patterns 22a, 22b are formed respectively. Then, the Ni/Au plating is applied to the connection portions 22x of the second wiring patterns 22a, 22b.

With the above, a wiring substrate 1d according to the fifth embodiment is obtained. The fifth embodiment can achieve the same advantages as the first and fourth embodiments. In addition to this, since the metal base substrate (or the metal substrate) can be employed as the core substrate by employing the coaxial conductive parts 21, such metal base substrate can improve various characteristics such as rigidity, thermal conductance, electromagnetic shielding, workability, etc. more advantageously than the insulating substrate.

What is claimed is:

1. A wiring substrate manufacturing method comprising the steps of:
preparing a core substrate having a through hole therein;
arranging the conductive parts in the through hole in a state that a top end side of the conductive parts forms a projected portion projected from the core substrate, by inserting a conductive parts having a length, which is longer than a thickness of the core substrate, into the through hole of the core substrate;
forming an insulating film on the core substrate to coat the projected portion of the conductive parts; and
planarizing the insulating film by grinding the insulating film.

2. A wiring substrate manufacturing method according to claim 1, wherein, in the step of planarizing the insulating film, the insulating film is left on the conductive parts.

3. A wiring substrate manufacturing method according to claim 1, wherein, in the step of planarizing the insulating film, the insulating film is ground until a top end surface of the conductive parts is exposed.

4. A wiring substrate manufacturing method according to claim 1, wherein the step of planarizing the insulating film includes the steps of,
grinding the insulating film until a top end surface of the conductive parts is exposed, and
forming an upper insulating film on the insulating film to coat the conductive parts.

5. A wiring substrate manufacturing method according to claim 1, after the step of planarizing the insulating film, further comprising the steps of:
forming a via hole in a portion of the insulating film on the conductive parts; and
forming a wiring pattern, which is connected to the conductive parts via the via hole, on the insulating film.

6. A wiring substrate manufacturing method according to claim 3, after the step of planarizing the insulating film, further comprising the step of:
forming a wiring pattern, which is connected to the conductive parts, on the insulating film.

7. A wiring substrate manufacturing method according to claim 1, wherein a wiring layer is provided on the core substrate, and the step of arranging the conductive parts in the through hole includes the step of connecting electrically the conductive parts and the wiring layer.

8. A wiring substrate manufacturing method according to claim 1, wherein the core substrate is an insulating substrate, and the conductive parts is a metal pillar, or the conductive parts has a coaxial structure composed of a metal pillar and an insulating member for coating an outer peripheral portion of the metal pillar.

9. A wiring substrate manufacturing method according to claim 1, wherein the core substrate is a single body of a metal plate or a metal base substrate having a laminated structure of a metal plate and an insulating layer, and the conductive parts has a coaxial structure composed of a metal pillar and an insulating member for coating an outer peripheral portion of the metal pillar.

10. A wiring substrate manufacturing method according to claim 1, wherein, in the step of arranging the conductive parts in the through hole, the conductive parts is arranged in a state that the projected portion is projected from both surface sides of the core substrate respectively, and
various steps executed after the step of arranging the conductive parts in the through hole are applied to both surface sides of the core substrate.
